(19) United States
(12) Patent Application Publication
(10) Pub. No.: US 2022/0245377 A1
(43) Pub. Date: Aug. 4, 2022

(54) AUTOMATED TEXT INFORMATION EXTRACTION FROM ELECTRONIC DOCUMENTS

(71) Applicant: Intuit Inc., Mountain View, CA (US)

(72) Inventors: Anu Singh, Los Altos, CA (US); Saikat Mukherjee, Fremont, CA (US)

(73) Assignee: Intuit Inc., Mountain View, CA (US)

(21) Appl. No.: 17/163,002

(22) Filed: Jan. 29, 2021

(51) Int. Cl. G06K 9/00; G06K 9/62; G06N 20/00; G06Q 40/00

(52) U.S. Cl. CPC G06K 9/00463; G06K 9/00449; G06Q 40/123; G06N 20/00; G06K 9/6215

(57) ABSTRACT

This disclosure relates to automatic text information extraction from electronic documents. An example system is configured to perform operations including obtaining text and one or more document features of an electronic document, clustering the text into one or more groups based on the one or more document features, and identifying one or more text strings from the text in one or more groups as one or more keys. Identifying the one or more text strings is based on the clustering. The system is also configured to perform operations including generating one or more key/value pairs. Generating one or more key/value pairs includes associating one or more values to the one or more keys (with a value including text outside of the one or more identified text strings). The system is further configured to output the one or more key/value pairs.

### TECHNICAL FIELD

This disclosure relates generally to systems for automated text extraction from electronic documents.

### DESCRIPTION OF RELATED ART

Many systems process information that is originally located in electronic documents to perform a function for a user. For example, tax preparation software generates a tax return form and any accompanying forms based on information located in employment income documents, bank statements, or other financial documents which may be available online or otherwise in an electronic format. Systems require the user to review the documents and manually type the information from the documents into the system. For example, US tax return preparation software instructs a user to input information from one or more W-2 forms, 1099 forms, and other documents in order for the software to prepare a tax return for the user. One problem is that manual input of information is susceptible to input errors by the user. Another problem is that requiring manual input by the user can decrease the user experience by requiring more of the user's time and understanding of the documents to review.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable features disclosed herein.

One innovative aspect of the subject matter described in this disclosure can be implemented as a method for automated extraction of text information from electronic documents. An example method includes obtaining text and one or more document features of an electronic document, clustering the text into one or more groups based on the one or more document features, and identifying one or more text strings from the text in one or more groups as one or more keys. Identifying the one or more text strings is based on the clustering. The method also includes generating one or more key/value pairs. Generating one or more key/value pairs includes associating one or more values to the one or more keys (with a value including text outside of the one or more identified text strings). The method further includes outputting the one or more key/value pairs.

In some implementations, identifying the one or more text strings as one or more keys includes identifying candidate text strings from the text in a group of the one or more groups, determining a similarity score for each candidate text string based on a content similarity between candidate text strings, and determining one or more of the candidate text strings as one or more keys based on the similarity score. Associating one or more values to the one or more keys may be based on a proximity of a value to a key in the electronic document and/or a content constraint on values associated with the key.

Another innovative aspect of the subject matter described in this disclosure can be implemented in a system for automated extraction of text information from electronic documents. In some implementations, the system includes one or more processors and a memory coupled to the one or more processors. The memory can store instructions that, when executed by the one or more processors, cause the system to perform operations including obtaining text and one or more document features of an electronic document, clustering the text into one or more groups based on the one or more document features, and identifying one or more text strings from the text in one or more groups as one or more keys. Identifying the one or more text strings is based on the clustering. Execution of the instructions also causes the system to perform operations including generating one or more key/value pairs. Generating one or more key/value pairs includes associating one or more values to the one or more keys (with a value including text outside of the one or more identified text strings). Execution of the instructions further causes the system to perform operations including outputting the one or more key/value pairs.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

FIG. 1 shows a block diagram of a system to automatically extract text information from electronic documents, according to some implementations.

FIG. 2 shows an example W-2 form used for text information extraction.

FIG. 3 shows an illustrative flowchart depicting an example operation for automated extraction of text information from an electronic document, according to some implementations.

FIG. 4 shows an illustrative flowchart depicting another example operation for automated extraction of text information from an electronic document, according to some implementations.

Like reference numbers and designations in the various drawings indicate like elements.

### DETAILED DESCRIPTION

The following description is directed to certain implementations for automated text information extraction from electronic documents. Extraction is discussed with reference to financial documents (such as tax related forms). However, a person having ordinary skill in the art will readily recognize that the teachings herein can be applied to a multitude of different electronic documents. It may be readily understood that certain aspects of the disclosed systems and methods can be arranged and combined in a wide variety of different configurations, all of which are contemplated herein.

Some processing systems require text from electronic documents for performing one or more tasks. For example, tax preparation software requires information from tax forms and other documents in order to prepare a tax return for a user. Some systems require users to manually type text from the documents (such as a user typing information from fields in his or her W-2 Wage and Tax Statement (referred to herein as a W-2 form) to prepare a US tax return). Requiring manual entry can be tedious and prone to errors (such as a user entering an incorrect field, transposing neighboring numbers, or missing or adding a number during entry). To alleviate the issues with manual entry, some systems use a template-based method for text information extraction from an electronic document. Documents of a similar type may have a similar format/layout, with similar entries in the same location in the documents. For example, W-2 forms from the same tax year have a similar layout with employee and employer information, income, tax, and other fields at defined locations in the form. A template indicates what text is to be included in the electronic document based on the known locations of text of different types in the document. For example, a template can indicate a location of a user's tax identification number (or other information) in an electronic W-2 form for the 2020 tax year based on the defined location within the document having a specific format. Therefore, a system can identify text in the form (such as an employee address, compensation, tax withheld, and so on) based on the text's location in the form as identified by a template specific to the form's format/layout. Templates are generated manually by a developer knowledgeable of the document layout and contents. When a new or updated type of document is released, the developer generates a new template for the new or updated document type.

A problem is that document formats/layouts change over time. For example, the Internal Revenue Service (IRS) adjusts a W-2 form's layout and text identifying fields in the form over the years. As a result, the location of information and text used to identify information in the document may change, and an existing template is no longer valid for extracting text information from documents having the new format. The developer thus must generate a new template for each update to the document format even though the document may include similar information as the previous format. As the number of different document types (with different formats) increases and the pace in updates to document formats increases, having a developer generate a new template for each new document format becomes unmanageable.

In some implementations, a system is configured to automatically extract text information from documents without the use of templates. The text information may be key/value pairs of text from a document. For example, a system may be configured to extract text and document features from an electronic document, cluster the text into groups based on the document features, identify text strings from the text as keys based on the clustering, generate key/value between text identified as keys and text not identified as keys in the document, and outputting the one or more key/value pairs. In this manner, a system to automate text information extraction without the use of templates may allow the system to continue to automatically extract text information after format updates or the release of new or revised electronic documents.

Various aspects of the present disclosure provide a unique computing solution to a unique computing problem that did not exist. More specifically, the problem of automated text extraction did not exist prior to the use of computer implemented systems to analyze information from vast numbers of electronic documents, and is therefore a problem rooted in and created by technological advances to electronic data ingestion and processing.

As the number of document types and formats increases, the ability to extract text information from the documents requires the computational power of modern processors and machine learning models to accurately extract such text. Therefore, implementations of the subject matter disclosed herein are not an abstract idea such as organizing human activity or a mental process that can be performed in the human mind, for example, because it is not practical, if even possible, for a human mind to extract text information from an electronic document and output a computer-readable format of the text information for processing by a computer-implemented system.

In the following description, numerous specific details are set forth such as examples of specific components, circuits, and processes to provide a thorough understanding of the present disclosure. The term “coupled” as used herein means connected directly to or connected through one or more intervening components or circuits. The terms “processing system” and “processing device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

In the figures, a single block may be described as performing a function or functions. However, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example systems and devices may include components other than those shown, including well-known components such as a processor, memory, and the like.

Several aspects of automated text information extraction from electronic documents will now be presented with reference to various apparatus and methods. These apparatus and methods will be described in the following detailed description and illustrated in the accompanying drawings by various blocks, components, circuits, devices, processes, algorithms, and the like (collectively referred to herein as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

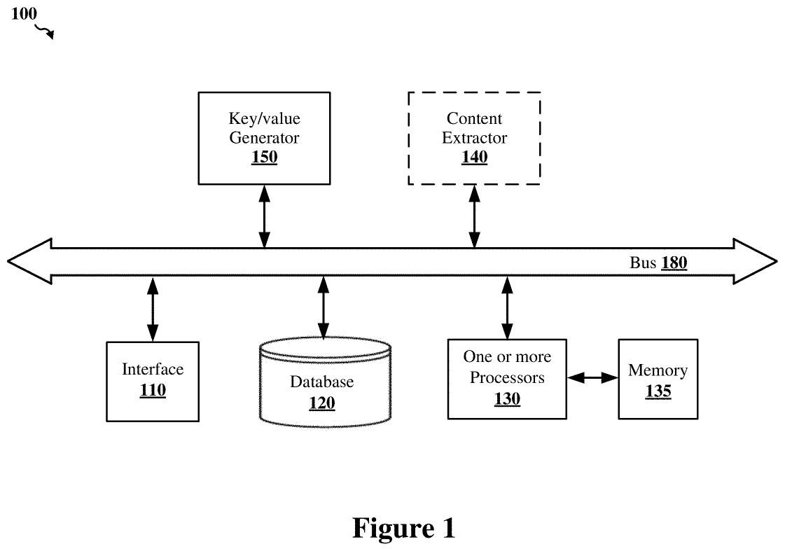

FIG. 1 shows a block diagram of a system 100 to automatically extract text information from electronic documents, according to some implementations. Although extracting text information is described herein as generating and outputting key/value pairs from financial documents (such as a W-2 form), the systems and methods described herein may be applied to any type of electronic document. The system 100 is shown to include an input/output (I/O) interface 110, a database 120, one or more processors 130, a memory 135 coupled to the one or more processors 130, a key/value generator 150, and a data bus 180. In some implementations, the system 100 also includes a content extractor 140. The various components of the system 100 may be connected to one another by the data bus 180, as depicted in the example of FIG. 1. In other implementations, the various components of the system 100 may be connected to one another using other suitable signal routing resources.

The interface 110 may include any suitable devices or components to obtain information (such as input data) to the system 100 and/or to provide information (such as output data) from the system 100. In some instances, the interface 110 may include a display and an input device (such as a mouse and keyboard) that allows a person to interface with the system 100 in a convenient manner. For example, the system 100 may execute a tax preparation software application stored locally on the system 100, and the interface 110 enables a user to interface with the tax preparation software. Additionally or alternatively, the interface 110 may include an ethernet port, wireless interface, or other means to wirelessly or wiredly communicate with one or more other devices. For example, the system 100 may host a tax preparation application that is accessed remotely by users.

The interface 110 can obtain one or more electronic documents. For example, a user's system may upload one or more electronic tax forms, or the system 100 may obtain the one or more tax forms directly from the institutions at the direction of the user (such as from the user's employer, bank, investment firm, and so on as instructed by the user). After generating the key/value pairs, the interface 110 may provide the key/value pairs in a computer-readable format (such as in a JavaScript Object Notation (JSON) file) to the user's device or another device used to process the key/value pairs. In some other implementations, the key/value pairs in a computer-readable format (such as the JSON file) is output for storage in the system 100 or for processing by the system 100 itself (such as in preparing a tax return form for the user through execution of a tax preparation application). In this manner, outputting may refer to providing an electronic file to be used by a portion of the system 100 or another device communicably coupled to the system 100.

The input data can include the text and one or more document features of an electronic document. For example, the electronic document is a native portable document format (PDF) file associated with text and one or more document features. The one or more document features may include one or more of locations of the text in the document (such as a location of each word or character string in the document), font properties of the text, objects in the document (such as a line, a curve, a rectangle, or other shapes in the document), or locations of the objects in the document.

In some implementations, the input data includes the electronic document itself (such as a PDF file). For example, the interface 110 may obtain a W-2 form from a user's employer or accounting service for the employer as a PDF file. If obtaining electronic documents as a whole, the system 100 includes the content extractor 140 to extract the text and one or more document features from the electronic document. For example, the content extractor 140 can extract the text portions and document features from the relevant portions of a native PDF file (such as described herein). Electronic documents for a user or associated with a user may refer to user-specific documents or documents associated with a person associated with the user. For example, if the system 100 executes a tax preparation application, a user may be a person interfacing with the system 100 to generate a tax return. The tax return can be for the user himself, the user's household, or another person for which the user is responsible for generating the tax return (such as a tax return preparer, a minor's guardian, and so on). Therefore, while the examples depict electronic documents specific to the user (such as the user's W-2 form), the electronic documents can include documents specific to a user's spouse or household, a person to which the user has a fiduciary duty, and so on.

As noted above, the output data can include the key/value pairs in a computer-readable format. In addition or to the alternative, the output data can include documents or other files generated by processing the key/value pairs. For example, the output data can include a tax return form generated by the system 100 executing a tax preparation application.

The database 120 can store any suitable information relating to the input data or the output data. For example, the database 120 can store the electronic documents to be processed and key/value pairs generated from processing the electronic documents. The database 120 may also store any information to be used by the system 100 in processing the electronic documents (such as any machine learning models, application scripts, or processing rules used by the key/value generator 150 to generate key/value pairs or the content extractor 140 to extract text and document features (to be used by the key/value generator 150) from the electronic documents). In some instances, the database 120 can include a relational database capable of manipulating any number of various data sets using relational operators, and present one or more data sets and/or manipulations of the data sets to a user in tabular form. The database 120 can also use Structured Query Language (SQL) for querying and maintaining at least portions of the database (such as the portion storing the key/value pairs), and/or can store the key/value pairs in tabular form, either collectively in a table or individually for each electronic document, document field, or other suitable unit.

The one or more processors 130, which may be used for general data processing operations, may be one or more suitable processors capable of executing scripts or instructions of one or more software programs stored in the system 100 (such as within the memory 135). The one or more processors 130 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the one or more processors 130 may be implemented as a combination of computing devices (such as a combination of a DSP and a microprocessor, a plurality of microprocessors, one or more microprocessors in conjunction with a DSP core, or any other such configuration).

The memory 135 may be any suitable persistent memory (such as one or more nonvolatile memory elements, such as EPROM, EEPROM, Flash memory, a hard drive, etc.) that can store any number of software programs, executable instructions, machine code, algorithms, and the like that, when executed by the one or more processors 130, causes the system 100 to perform at least some of the operations described below with reference to one or more of the Figures. In some instances, the memory 135 can also store electronic document, text, document features, or tools for use by the components 140 or 150.

If the system 100 is to extract text and document features from electronic documents obtained by the system 100, the content extractor 140 is configured to extract such information from the electronic documents. For example, the content extractor 140 extracts text and document features from one or more native PDF files. In extracting the document features, the content extractor 140 extracts text locations, font properties, objects in the document, and object locations. If the electronic documents are PDF files, the content extractor 140 may include any suitable PDF parsing tool to extract raw content from the PDF files. In some implementations, the content extractor 140 can implement the PDFminer parsing tool in Python. The document objects extracted by the PDFminer tool include one or more of lines represented by an LTLine data structure from PDFminer, one or more curves represented by an LTCurve data structure from PDFminer, or one or more rectangles represented by an LTRect data structure from PDFminer. The text extracted by the PDFminer tool are represented by LTText, LTChar, and other text data structures from PDFminer. Each data structure may include an indication of the location of the associated content (such as for a line, a text character, and so on) in the PDF document. In some implementations, if the PDF document includes multiple pages, the data structures for the text and objects may be associated with a specific page of the document represented by an LTPage data structure from PDFminer. The raw content extracted by the content extractor 140 is provided to the key/value generator 150, and the key/value generator 150 generates the key/value pairs for the electronic document.

The key/value generator 150 is configured to generate key/value pairs for the electronic document from the text and one or more document features of the electronic document. For example, the key/value generator 150 may obtain the LTText and LTChar data structures associated with the text and the LTLine, LTCurve, and LTRect data structures associated with the objects, and the key/value generator 150 processes the data structures to generate key/value pairs for the electronic document. As used herein, a key/value pair refers to a key and associated value of text in the electronic document. A key refers to a text information to exist in the type of document being processed. For example, if the electronic document is a W-2 form (such as in a PDF) provided for the user by the user's employer, keys associated with a W-2 may include employer name, employer address, employee name, employee address, employee identifier (ID), wages, federal income tax withheld, social security wages, social security tax withheld, and other fields in the W-2 form. A value associated with the key refers to the user-specific information for the key. For example, the key “employee name” may be associated with a value of the user's name included in the form, the key “wages” may be associated with a value of the user's obtained wages as indicated in the form. In generating the key/value pairs by the key/value generator 150, the key/value pairs may be included in a computer-readable file or other computer-readable object. For example, a JSON object including an array of key/value pairs may be generated for the electronic document, a page of the electronic document, or another portion of the electronic document. In another example, a JSON object may include key/value pairs generated across multiple electronic documents for the user.

The content extractor 140 and the key/value generator 150 may be incorporated in software (such as software stored in memory 135) and executed by one or more processors (such as the one or more processors 130), may be incorporated in hardware (such as one or more application specific integrated circuits (ASICs)), or may be incorporated in a combination of hardware or software. For example, one or both of the components 140 and 150 may be coded using Python for execution by the one or more processors 130. In addition or to the alternative, one or both of the components 140 and 150 may be combined into a single component or may be split into additional components not shown. The particular architecture of the system 100 shown in FIG. 1 is but one example of a variety of different architectures within which aspects of the present disclosure may be implemented.

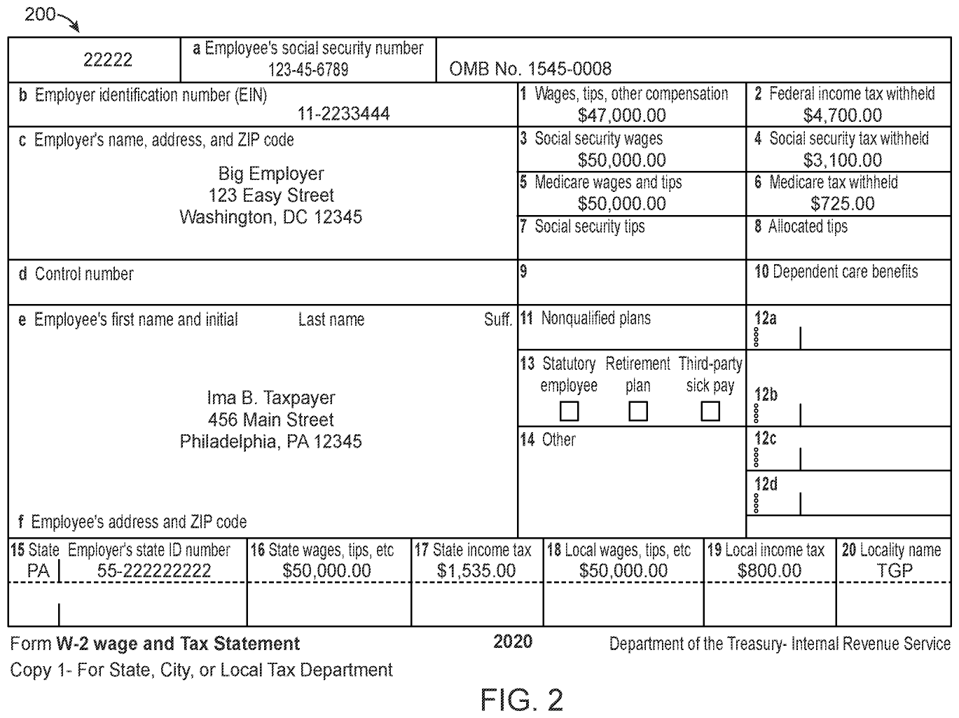

The system 100 is configured to generate and output key/value pairs from one or more electronic documents. In the example methods below, operations to generate and output example key/value pairs are described with reference to the example W-2 form 200 depicted in FIG. 2. The key/value pairs may be used in generating a tax return by the system 100 (or another suitable device). For example, the system 100 uses the key/value pairs from the W-2 form 200 in generating a 1040 tax return document for the IRS.

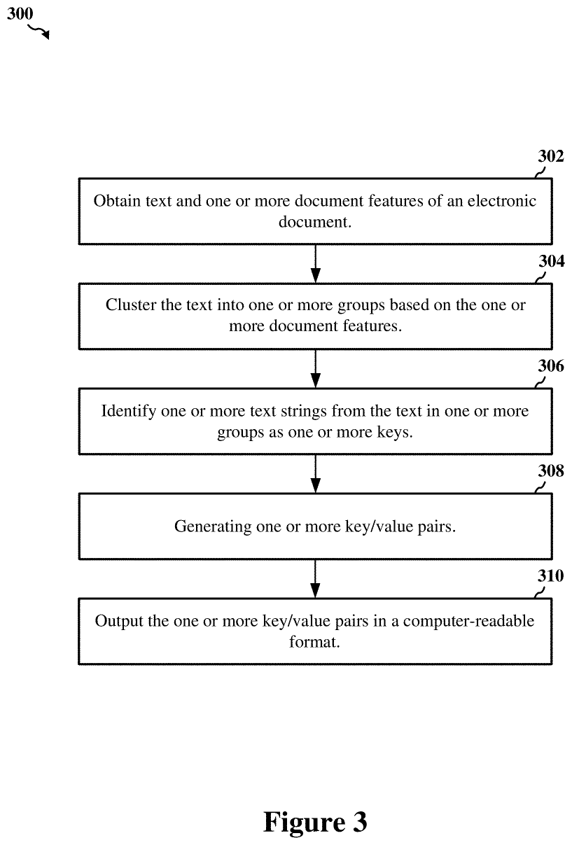

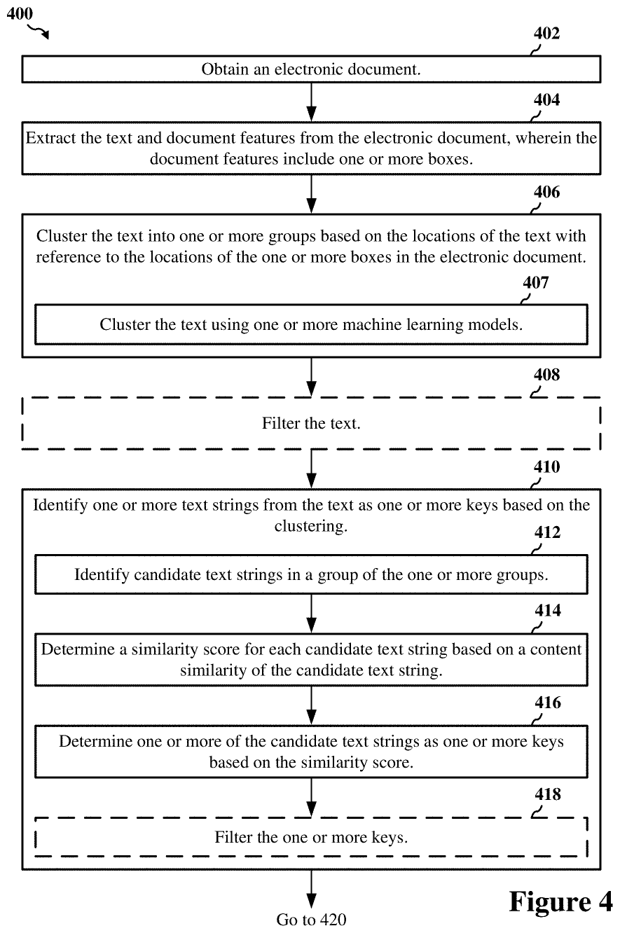

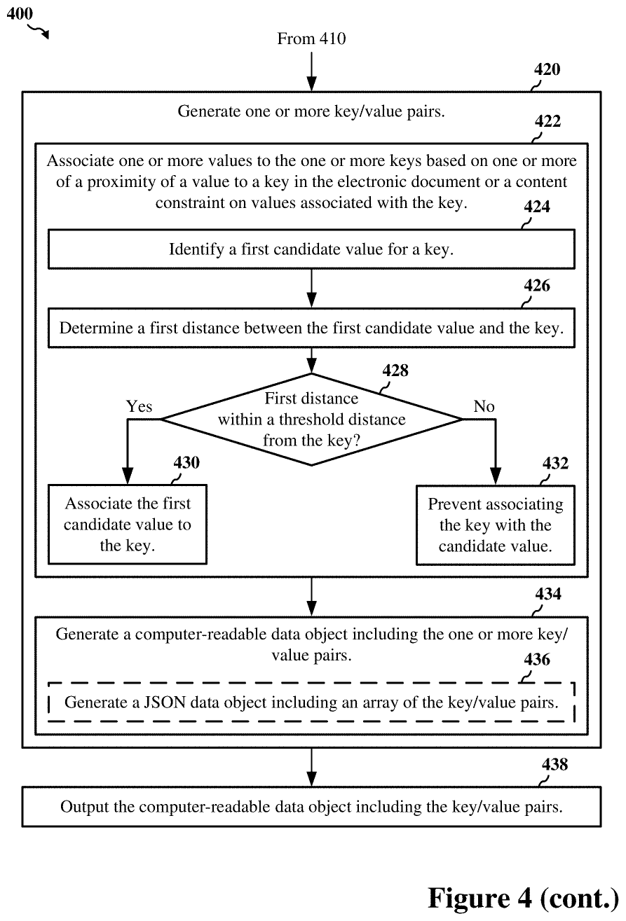

As noted above, FIG. 2 shows an example W-2 form 200 used for text information extraction. The W-2 form 200 includes a plurality of boxes containing information regarding the user “Ima B. Taxpayer.” As used herein, a box refers to an enclosed area of the electronic document that is to be filled or contains separate printed matter from the text of the generic document. For example, boxes in the W-2 form 200 may include the rectangles for the different fields (such as field “a” for Employee's social security number, field “b” for Employer's identification number (EIN), and so on). Extracting text information (such as generating key/value pairs) from an electronic document is described below with reference to example operations 300 and 400 (FIGS. 3 and 4) for the example W-2 form 200. While the below examples describe analyzing text from the same box of an electronic document to generate key/value pairs, in some implementations, text from neighboring boxes may be used for generating key/value pairs. For example, a value may be in a box to the right of the box including the key. In another example, a value may be in a box below the box including the key. In some implementations, the system 100 is configured to generate the candidate values from text spanning multiple boxes. In addition, while the below examples to generate and output the key/value pairs from an electronic document are described with reference to W-2 forms for clarity in describing aspects of the present disclosure, the example operations may extend to other financial documents (such as 1099 forms) or non-financial documents for various processing systems.

FIG. 3 shows an illustrative flowchart depicting an example operation 300 for automated extraction of text information from an electronic document, according to some implementations. The example operation 300 is described as being performed by the system 100 (such as by the one or more processors 130 executing instructions to perform operations associated with the components 140 or 150). At 302, the system 100 obtains text and one or more document features of an electronic document. For example, the system 100 may obtain data structures generated by the PDFminer tool implemented on another device. In some other implementations, the system 100 (such as the content extractor 140 implementing the PDFminer tool) may extract the text and one or more document features from an electronic document. The extracted text and one or more document features may be provided to the key/value generator 150 to generate one or more key/value pairs.

The text may include LTChar structures within LTText structures within LTTextLine structures generated for the electronic document by the PDFminer extraction tool. Multiple LTTextLine structures may be associated with a LTTextBox structure. Each data structure may include an indication of the location of the associated text in the document. The text locations (and locations of other objects) may be considered document features. Each structure also may include an indication of one or more font properties of the text. Example font properties include font type, font size, character spacing, capitalization, alignment, indentation, justification, underlining, bolding, italicizing, subscript, superscript, or other properties specific to the text in the text data structures. The font properties also may be considered document features. In this manner, the text structures may include text and one or more document features.

The one or more document features also include one or more boxes (and the locations of the one or more boxes in the document). A box may be defined by one or more lines, curves, rectangles, or other objects in the electronic document. For example, the PDFminer extraction tool may generate one or more LTLine, LTCurve, or LTRect data structures indicating the lines, curves, and rectangles, respectively, in the electronic document. Alternatively, a text box may be determined based on the proximity of text (such as the proximity of tokens to one another identified by LTText data structures) and the demarcation or proximity of lines, curves, rectangles in the document to the text. The text box may also be based on font and other text properties. The system 100 may use the data structures to determine one or more boxes in the electronic document based on the lines, curves, or rectangles enclosing a space on the electronic document or a spacing of the text in the electronic document.

Referring back to FIG. 2, a PDFminer extraction tool may generate a LTLine data structure for each line segment in the W-2 form 200. The PDFminer extraction tool may also generate a LTRect data structure for each rectangle. In some implementations, a LTRect data structure may be for a rectangle including multiple smaller rectangles. For example, a first LTRect data structure may be generated for the rectangle including fields 1, 2, 3, and 4 (for which a second, third, fourth, and fifth LTRect data structure may be generated, respectively). A sixth LTRect data structure may be generated for the rectangle including fields 1 and 2, a seventh LTRect data structure may be generated for the rectangle including fields 1 and 3, an eighth LTRect data structure may be generated for the rectangle including fields 2 and 3, and a ninth LTRect data structure may be generated for the rectangle including fields 3 and 4. In this manner, the first LTRect data structure is associated with an area of the W-2 form including nine rectangles (for which nine LTRect data structures may be generated). Regarding LTLine data structures, each line segment may be associated with an LTLine data structure, and an LTLine data structure may be associated with one or more line segments. An end of a line segment can be indicated by a terminus of the line or an intersection or junction of the line by another line. For example, each rectangle may be associated with four LTLine data structures for the four sides of the rectangle. The data structures include an indication of the location of the object in the electronic document and one or more properties of the object. Example property objects include a line weight, direction of a line, curve, or rectangle (such as whether vertical or horizontal), size of the line, curve, or rectangle (such as length and/or width), or a pattern of the line (such as whether the line is dashed or solid).

As noted above, the system 100 may use the data structures to determine one or more boxes in the electronic document based on the lines, curves, or rectangles enclosing a space on the electronic document. In some implementations, boxes are associated with the smallest rectangles (or other shapes) in the electronic document. A smallest rectangle or shape refers to a rectangle not including any additional rectangles or shapes in the rectangle. The smallest shape may be determined from the LTRect data structures or a joinder of lines or curves from the LTLine data structures or LTCurve data structures to enclose a space of the electronic document that does not include additional rectangles or shapes (defined by the data structures). Alternatively, while the above examples describe boxes with reference to areas of the document enclosed by lines, curves, or rectangles, a box may refer to a text box associated with an area of related text in the document. A text box may be determined based on the proximity of text (such as the proximity of tokens identified by LTText data structures) and the demarcation or proximity of lines, curves, rectangles in the document to the text. The text box may also be based on font and other text properties.

In some implementations, a box may be defined on one or more sides by an edge of the electronic document. For example, while the W-2 form 200 includes lines on the outer edges of the fields towards the edge of the form 200, a page boundary of an electronic document may be used to indicate an edge of a box (without the use of a line). The system 100 may determine from the data structures whether lines or curves are prevented from enclosing a space on the electronic document based on the page edge. For example, each page edge may be treated as a separate LTLine data structure to be used in determining whether the data structures (including the structures for the page edges) define shapes that enclose spaces in the document. Some documents may include the images, text, and objects to be spaced from the page edge by a defined spacing. In the above example of data structures for the page edges, the data structures associated with the page edges may be generated with the spacing taken into account.

At 304, the system 100 clusters the text from the electronic document into one or more groups based on the one or more document features. As noted above, boxes of the electronic document may be determined based on the smallest rectangles or enclosed shapes (or locations and proximities of text) in the electronic document. In this manner, clustering the text from the electronic document is based on the boxes determined for the electronic document.

Referring back to FIG. 2, the boxes determined for the W-2 Form 200 may include three boxes for the top row of smallest rectangles (including the middle box associated with the employee's social security number), include three boxes for the second row of smallest rectangles (including boxes associated with a EIN, employee wages, and federal income tax withheld), and so on). Referring to the rectangle for field 15 (State and Employer's state ID number) on the bottom left portion of the W-2 form, the rectangle may be associated with one box. As can be seen, a line segment exists in the middle of the rectangle. In some implementations, the system 100 may determine whether the rectangle is to be divided into two boxes based on the line segment. For example, the system 100 may determine the height/length of the line segment as compared to a threshold. If the line segment is longer than the threshold, the system 100 divides the rectangle into two boxes (such as the line segment being longer than half the height of the rectangle).

As noted above, the text may be indicated in text data structures from the content extractor 140 (such as the PDFminer tool). Referring to FIG. 2, each text character in the W-2 form 200 is associated with a LTChar data structure indicating the specific character (such as the alphabetic, numeric, or special character) and font properties of the character (including the font type, size, and style (whether italics, underline, or bold)). The text characters are grouped for a LTText data structure. For example, each LTText data structure may be associated with a word or number based on the spacing between characters. The words are grouped based on the line of the words for a LTTextLine data structure (which may indicate line properties, such as line spacing, justification, alignment, or indention). Text lines may be grouped based on the spacing between different lines of text and other text from the document for a LTTextBox data structure. For example, the user specific employer name and address text in field c of the W-2 form 200 may be broken into one LTTextBox data structure associated with three LTTextLine data structures. The first LTTextLine data structure is associated with two LTText data structures for “Big” and “Employer.” In this manner, the PDFminer may parse the text into 1-tuples (such as based on the LTText data structures). The first LTText data structure for “Big” is associated with three LTChar data structures for “B,” “i,” and “g.”

The text and document features obtained by the system 100 (such as the text and object data structures provided by the content extractor 140 implementing the PDFminer tool) are provided to the key/value generator 150 for the key/value generator 150 to generate the key/value pairs for the electronic document. As noted above, the document features may include indications of the boxes determined in the electronic document. Steps 304-310 of operation 300 in FIG. 3 are described below, which may be performed by the key/value generator 150 of the system 100.

Referring back to FIG. 3, at 304, the system 100 clusters the text in the electronic document into one or more groups based on the one or more document features. For example, the text in field c of the W-2 form 200 may be clustered into a group based on the location of the text with reference to locations of other text, the location of the text to a location of a box for field c, or other document features. More details of the system 100 clustering the text are described below with reference to the example operation 400 in FIG. 4.

With the text clustered into one or more groups, at 306, the system 100 identifies one or more text strings (from the text in one or more groups) as one or more keys. Identifying the one or more text strings is based on the clustering of the text into groups. As used herein, a text string may refer to a 1-tuple or multi-tuple of text. Each word or number may be a 1-tuple based on the LTText data structures. The key/value generator 150 may join neighboring 1-tuples based on grammar and punctuation rules to generate a multi-tuple. In some implementations, the system 100 (such as the database 120) may store a dictionary indicating the rules used to join terms into a text string. For example, “Employer's name, address, and ZIP code” text in field c (which is associated with one LTTextLine) may be processed using the dictionary to join 1-tuples “Employer's” and “name” to generate a first multi-tuple/text string “Employer's name” based on capitalization of the first word and the apostrophe indicating a possessive noun after the first word. The first text string is separated from a second text string “address” by a first comma, and the second text string is separated from a third text string “ZIP code” by a subsequent comma. In some implementations, terms may be included in multiple candidate text strings. For example, the term “ZIP” may be associated with a candidate text string “ZIP” and a candidate text string “ZIP code.” Joinder of 1-tuples to generate candidate text strings is from the text in one group determined from clustering, and the system 100 may attempt to determine candidate text strings for each group of text. The system 100 then determines whether one or more of the candidate text strings are keys associated with the W-2 form 200. Example implementations of identifying a text string as a key for the electronic document is described in more detail below with reference to the example operation 400 in FIG. 4.

Referring back to FIG. 3, at 308, the system 100 generates one or more key/value pairs. To generate one or more key/value pairs, the system 100 associates one or more values to the one or more keys identified in step 306. With some text strings identified as keys, there is a remainder of the text in the electronic document that is not identified with a key. A value, as used herein, is a text string not identified with a key. In this manner, for a key appearing in a group, the system 100 determines a value associated with the key. Example implementations of associating a value to a key is described in more detail below with reference to the example operation 400 in FIG. 4. While the below examples are regarding matching values to keys from the same box, matching may be across multiple boxes in some implementations. For example, a value may be in a box to the right of the box including the key. In another example, a value may be in a box below the box including the key. In some implementations, the system 100 is configured to generate the candidate values and match values to keys spanning multiple boxes.

At 310, the system 100 outputs the one or more key/value pairs in a computer-readable format. For example, the key/value pairs may be included in an JSON array or other data object which is provided to another device (such as via the interface 110) or to another application (such as being executed by the one or more processors 130). In some implementations, a file including the JSON data object with the key/value pairs may be stored by the system 100 (such as in the database 120 or the memory 135) for further processing. For example, the data object may be stored for use in generating a tax return by the system 100 executing a tax return preparation application.

FIG. 4 shows an illustrative flowchart depicting another example operation 400 for automated extraction of text information from an electronic document, according to some implementations. The example operation 400 may be an implementation of the operation 300 in FIG. 3. In this manner, the operation 400 includes additional example implementation details of the process outlined by operation 300 in FIG. 3. The example operation 400 is described as being performed by the system 100 (such as by the one or more processors 130 executing instructions to perform operations associated with the components 140 and 150).

At 402, the system 100 obtains an electronic document. For example, the system 100 may obtain (via the interface 110) a native PDF document uploaded by the user or obtained from another device (such as from a financial institution or employer for 1099 forms and W-2 forms). At 404, the system 100 extracts the text and document features from the electronic document (with the document features including one or more boxes for the electronic document). For example, the content extractor 140 implementing the PDFminer tool generates the data structures for the text and objects in the PDF document as described above. The content extractor 140 also determines the boxes in the PDF document based on the object data structures (and/or text data structures) from the PDFminer tool.

At 406, the system 100 (such as the key/value generator 150) clusters the text into one or more groups based on the locations of the text with reference to the locations of the one or more boxes in the electronic document. During clustering, text tokens are divided and grouped based on locations of the tokens to each other and to the objects (such as the edges of a box). As used herein, a text token or unigram refers to a 1-tuple of the text (which may be indicated by the LTText data structures).

Clustering the text in step 406 is performed by using one or more machine learning models (407). In some implementations, the system 100 performs Hierarchical Clustering on the text tokens based on locations of the tokens in the page and font size. In some implementations, Hierarchical Clustering is also based on font type, style, or other font properties of the text. Use of Hierarchical Clustering may also be used to group text for an area of the electronic document that is not completely enclosed by the objects in the document (such as as a result of the edge of the page acting as an edge of a rectangle or other shape). During Hierarchical Clustering, the tokens are recursively merged into larger and larger groups with a distance and similarity measurement between the intermediate groups being merged. The system 100 determines the final groups of text based on the distance and similarity measurement. In some implementations, the system 100 may generate a dendrogram that is analyzed to determine the final groups. The system 100 may determine the success rate of generating key/value pairs for each document based on the clustering (such as determining the number or proportion of keys for the document associated with incorrect values or the number of keys not associated with a value). As text from more and more documents are clustered, the system 100 uses a machine learning model to analyze the success rate and distance and similarity measurement associated with each success rate to adjust its use of the distance and similarity measurement to determine the final groups. In this manner, the system 100 automatically learns and adapts its clustering operations to improve the success rate of generating the key/value pairs.

Any suitable machine learning model may be used. For example, the machine learning model may be based on one or more of decision trees, random forests, logistic regression, nearest neighbors, classification trees, control flow graphs, support vector machines, naïve Bayes, Bayesian Networks, value sets, hidden Markov models, or neural networks configured to determine the final groups of text (which may also be referred to as clusters). In some implementations, the one or more machine learning models used by the key/value generator 150 (such as being executed by the one or more processors 130) may be stored in the database 120 or the memory 135 of the system 100.

In some implementations, the system 100 filters the text after clustering (408). Characters not needed for key/value pairs may be included in the text. In some implementations, one or more tokens may not be grouped into a cluster in 406. The system 100 may remove or delete the characters for the ungrouped tokens (such as the LTChar data structures for the ungrouped LTText data structures). In some implementations, certain character types may not be used for the key/value pairs associated with the electronic document. For example, non-alphanumeric characters (such as punctuation, spaces, or special characters (which may include currency symbols, decimals, and so on)) are not needed, and the system 100 removes the non-alphanumeric characters. In another example, a cluster may include repeated text. The system 100 removes the repeated text so that one instance of text appears in the cluster. Repeated text may refer to multi-tuples identified by the system 100 as appearing more than once in the cluster. In this manner, the keys and values generated for the electronic document do not include the removed text (such as the removed characters or repeated text).

At 410, the system 100 identifies one or more text strings from the text as one or more keys based on the clustering. Steps 412-418 depict example operations for identifying one or more text strings as keys. At 412, the system 100 identifies candidate text strings in a group of text. Such identification may be performed for each group of text (or across multiple groups of text) for the document. As noted above with reference to step 306 in FIG. 3, the system 100 may determine candidate text strings based on punctuation and grammar in the text. In some implementations, filtering repeated text and characters may be performed by the system 100 during or after generation of the candidate text strings, with the characters associated with punctuation and grammar used in identifying the candidates.

At 414, the system 100 determines a similarity score for each candidate text string based on a content similarity of the candidate text string. The electronic document is associated with a plurality of typical/standard keys for the document type. In some implementations, the system 100 uses a lexicon to identify keys in the grouped text. For example, the lexicon includes a list of standard keys for the document type. The lexicon may also include a list of potential text strings associated with each key. For example, a key for the user's federal wages associated with the W-2 form 200 may be associated with potential text strings “wages,” “compensation,” “federal wages,” “income,” “federal income,” and so on. The lexicon can include the key and the potential text strings for comparison to the text strings from one or more groups of text for the W-2 form 200. The system 100 may compare the candidate text strings to the potential text strings to determine similarity scores between a candidate and potential text strings (with the similarity score indicating a content similarity between the candidate text string and the key (or the potential text strings associated with the key)).

In some implementations, the key/value generator 150 implements the Universal Sentence Encoder (USE) in Python to perform natural language processing tasks on the grouped text and determine a similarity score. The portion of the key/value generator 150 implementing USE may be stored in the database 120 or memory 135 and executed by the one or more processors 130. USE is used to encode grouped text into multiple-dimension vectors for the text strings. Each dimension of a vector for a text string includes a similarity score (which may be referred to as a semantic similarity score) between the text string and a standard key for the type of electronic document. The similarity score is determined based on a content similarity between the text string and key (or potential text strings for the key) determined by the trained encoder. The USE to generate semantic similarity scores may be trained using a Deep Averaging Network (DAN) or other suitable machine learning models.

At 416, the system 100 determines one or more of the candidate text strings as one or more keys based on the similarity score. In some implementations, the multiple-dimension vectors (generated by the USE and including the similarity scores for the candidate text strings) are used by the system 100 to match one or more of the candidate text strings to one or more or the standard keys for the document type. For example, the system 100 uses Bipartite Matching on a matrix including the multiple-dimension vectors as rows to match one or more of the candidate text strings to the standard keys. In some implementations, the key/value generator 150 implements the SciPy implementation of the Hungarian Algorithm in Python to perform Bipartite Matching. The implementation may be stored in the database 120 or the memory 135 and executed by the one or more processors 130. Through Bipartite Matching, the system 100 increases an aggregated similarity score of the matched text strings and keys as compared to other combinations of matches between the text strings and the keys.

One or more of the determined keys may be an outlier to the other determined keys in step 416. For example, all keys except one may be located in a portion of the electronic document, and the one key may be separated from the other keys by a Euclidian distance in the document. In another example, most keys may have one or more of a similar font type, a similar font style, a similar font size, or other font properties (which may be indicated in the data structures from the PDFminer), and one key's font properties may differ from the other keys' similar font properties. In some implementations, the system 100 filters the one or more keys to remove one or more outlier keys from the one or more keys (418). To identify an outlier key, the system 100 may determine a quantitative measurement of font properties between identified keys and a distance between identified keys (such as a distance between a key and the center of the remaining keys). For measuring font properties, font size and character spacing may be measured in number of pixels or a unit of length. A comparison of font sizes or character spacings may be the difference between the measurements. Font type (such as whether Arial or Times New Roman) or font style (such as whether underlined or bold) may be indicated by a alphanumeric code. Comparison of font types or font sizes may be whether the alphanumeric codes match each other.

The system 100 is configured to determine a z-score for each key (with the z-score indicating a similarity of the key to the other keys based on font properties and proximity between the key and other keys). The z-score is associated with a standard deviation from a mean similarity among the keys from the distances and font properties. In some implementations, the key/value generator 150 implements a trained engine to combine the measurements into a z-score (with the engine being trained using any suitable machine learning model). The system 100 then determines whether a key is an outlier based on the z-scores. For example, a key may be identified as an outlier if the z-score is greater than a threshold. The system 100 removes the one or more outlier keys that are identified from the one or more keys used in generating the key/value pairs. In some implementations, filtering the keys may cause one or more standard keys associated with the document type to not be identified in the document or to not be associated with a value.

With the system 100 having identified one or more text strings as one or more keys in step 410, the system 100 generates one or more key/value pairs for the identified one or more keys (420). Generating the key/value pairs includes associating one or more values to the one or more keys (422). As noted above, values include grouped text not in text strings that are identified as keys. The association between values and keys is based on one or more of a proximity of a value to a key or a content constraint on the values associated with the specific key. Regarding proximity, the system 100 measures a distance between the potential values and a key in a group. The distance may be a Euclidian distance measured in pixels or units of length (such as centimeters). Regarding content constraints, some keys are associated with specific format values. For example, a social security number key is associated with a nine digit number. A wages key is associated with a number representing a dollar amount. A ZIP code key is associated with a 5 digit number or 9 digit number. A user's name key is associated with a two or three consecutive token value indicating the first and last name of the user (which is without numbers or other non-alphabet characters). In some implementations, the lexicon of candidate keys can include content constraints or content rules for the values of each key. In this manner, the system 100 may generate candidate values or remove candidate values based on the content constraints defined in the lexicon. The lexicon rules may be based on domain specific knowledge or specific knowledge of the document type.

In some implementations, the content constraints may indicate that a key is to be associated with a multi-tuple value. In this manner, the system 100 limits generating candidate values to the defined multi-tuples of text. For example, a name key may be associated with a rule of being paired with a two or three token value. The system 100 may thus generate two and three token candidate values for the name key of the document.

In some implementations, the content constraints may be associated with an address. The lexicon may include segmentation rules for an address key to generate the address value, or the system 100 may use any suitable segmentation tool to segment a matched value into separate values for other keys (such as for a street number key, a street name key, a city key, a state key, and a ZIP code key).

The system 100 attempts to match the candidate values to the key based on the distances between the candidate values and the key. Steps 424-432 depict an example implementation of associating a value to a key based on the distance (422).

At 424, the system 100 identifies a first candidate value for a key. The first candidate value may be a candidate value that is the closest distance wise to the key from other candidate values. At 426, the system 100 determines a first distance between the first candidate value and the key. At decision block 428, if the first distance is within a threshold distance from the key in the group, the system 100 associates the first candidate value to the key (430). If the first distance is not within the threshold distance, the system 100 prevents associating the key with the candidate value (432).

In some implementations, the system 100 may determine a plurality of candidate values, and the plurality of candidate values may be compared for one or more keys. The plurality of candidate values includes the first candidate value from step 424. In matching a candidate value to a key, for each candidate value, the system 100 determines the distance between the candidate value and the key. In some implementations, the matched candidate value is to be within a threshold distance of the key. For example, in practice, the further away a text string is from the key in the document, the less likely that the text string is the value for the key. The threshold distance may be an absolute distance or may be based on the distances associated with the other candidate values for the key.

In some implementations, the system 100 divides the candidate value distances into quartiles (25 percent, 50 percent, 75 percent and 100 percent) of distances ranked by the shortest distances, with the top quartile referring to the top 25 percent of the shortest distances. Candidate values not associated with the top quartile are not to be matched to the key. In this manner, the system 100 excludes the candidate values associated with the distances in the bottom three quartiles from being matched to the key.

The system 100 determines if the closest candidate value in the quartile complies with the content constraints for the key (such as described above). If the candidate value does not comply with the content constraints, the system 100 determines if the next closest candidate value complies with the content constraints. The process may repeat until a candidate value complies with the content constraints or no further candidate values exist in the quartile. If no further candidate values exist, the system 100 prevents matching the key to any values in the electronic document. While quartiles are described for the threshold distance, any suitable quantiles may be used in determining the threshold distance within which a value is to be from the key in the electronic document.

Having associated one or more values to the one or more keys in step 422, the system 100 generates a computer-readable data object including the one or more key/value pairs (434). In some implementations, the system 100 (such as the key/value generator 150) generates a JSON data object including an array of the key/value pairs (436). The JSON data object may be included in a file, script, call, or other suitable computer-readable code. In some implementations, the JSON data object may exclude keys not matched to values. In some other implementations, the JSON data object may include the unmatched keys with a blank value or otherwise indicate that the key is unmatched. In some further implementations, the JSON data object may indicate if any standard keys associated with the document type are not identified in the document.

At 438, the system 100 outputs the computer-readable data object including the key/value pairs. In some implementations, the generated JSON data object may be provided to the database 120 or the memory 135 for storage, may be provided to the one or more processors 130 executing an application for processing, or may be provided to the interface 110 for transmission to another device. For example, the JSON data object may be processed by the one or more processors 130 executing a tax return preparation application to generate a tax return for the user. However, any other suitable uses for the data object including the key/value pairs may be envisioned.

The above examples depict example implementations for a system to automatically extract text information from electronic documents (such as key/value pairs from native PDF documents). As described, the automatic extraction of text information can be performed without the use of manually generated templates for each document type. In this manner, automatic extraction of text information may continue for documents even after document format updates or other changes to documents, improving the maintenance of text ingestion and processing tools for performing a variety of tasks for a user (including tax preparation or financial management tools).

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

1. A computer-implemented method for extracting text information from an electronic document, comprising:
obtaining text and one or more document features of the electronic document;
clustering the text into one or more groups based on the one or more document features;
identifying one or more text strings from the text in the one or more groups as one or more keys, wherein identifying the one or more text strings is based on the clustering;
generating one or more key/value pairs, including associating one or more values to the one or more keys, wherein a value includes text outside of the one or more identified text strings; and
outputting the one or more key/value pairs in a computer-readable format.

2. The method of claim 1, wherein the one or more document features include:
locations of the text in the electronic document; and
locations of one or more boxes identified in the electronic document, wherein clustering is based on the locations of the text with reference to the locations of the one or more boxes.

3. The method of claim 2, wherein identifying the one or more text strings as one or more keys includes:
identifying candidate text strings from the text in a group of the one or more groups;
determining a similarity score for each candidate text string based on a content similarity of the candidate text string; and
determining one or more of the candidate text strings as one or more keys based on the similarity score.

4. The method of claim 3, further comprising filtering the one or more keys after determining one or more of the candidate text strings as one or more keys, including:
detecting one or more outlier keys in the one or more keys based on one or more of:
one or more font properties of an outlier key in the electronic document, wherein the one or more document features includes the one or more font properties; or
a proximity of the outlier key to the one or more keys in the electronic document; and
removing the one or more outlier keys from the one or more keys.

5. The method of claim 3, wherein associating one or more values to the one or more keys is based on one or more of:
a proximity of a value to a key in the electronic document; or
a content constraint on values associated with the key.

6. The method of claim 5, wherein associating one or more values to the one or more keys includes:
identifying a first candidate value for a key;
determining a first distance between the first candidate value and the key;
determining whether the first distance is within a threshold distance from the key; and
associating the first candidate value to the key based on determining that the first distance is within the threshold distance, wherein the key remains unassociated with a value when the first distance is greater than the threshold distance.

7. The method of claim 6, wherein associating one or more values to the one or more keys further includes:
identifying a plurality of candidate values for the key, wherein the plurality of candidate values includes the first candidate value; and
determining a distance between each of the plurality of candidate values and the key, wherein the first distance is the smallest distance from the determined distances.

8. The method of claim 5, further comprising generating a plurality of values including the one or more values associated to the one or more keys, wherein generating the plurality of values includes one or more of:
generating a multi-tuple included in the one or more values, including:
dividing the text not included in the one or more keys in the electronic document into a plurality of 1-tuples; and
combining a portion of the plurality of 1-tuples into the multi-tuple based on one or more domain specific rules for the electronic document, wherein the multi-tuple is included in the plurality of values; or
segmenting values associated with an address key based on one or more address format rules.

9. The method of claim 2, wherein obtaining the text and one or more document features includes:
obtaining the electronic document; and
extracting the text and the one or more document features from the electronic document.

10. The method of claim 2, further comprising filtering the text included in the one or more groups before identifying the one or more text strings.

11. A system for extracting text information from an electronic document, comprising:
one or more processors; and
a memory coupled to the one or more processors and storing instructions that, when executed by the one or more processors, cause the system to perform operations comprising:
obtaining text and one or more document features of the electronic document;
clustering the text into one or more groups based on the one or more document features;
identifying one or more text strings from the text in the one or more groups as one or more keys, wherein identifying the one or more text strings is based on the clustering;
generating one or more key/value pairs, including associating one or more values to the one or more keys, wherein a value includes text outside of the one or more identified text strings; and
outputting the one or more key/value pairs in a computer-readable format.

12. The system of claim 11, wherein the one or more document features include:
locations of the text in the electronic document; and
locations of one or more boxes identified in the electronic document, wherein clustering is based on the locations of the text with reference to the locations of the one or more boxes.

13. The system of claim 12, wherein identifying the one or more text strings as one or more keys includes:
identifying candidate text strings from the text in a group of the one or more groups;
determining a similarity score for each candidate text string based on a content similarity of the candidate text string; and
determining one or more of the candidate text strings as one or more keys based on the similarity score.

14. The system of claim 13, wherein execution of the instructions causes the system to perform operations further comprising filtering the one or more keys after determining one or more of the candidate text strings as one or more keys, including:
detecting one or more outlier keys in the one or more keys based on one or more of:
one or more font properties of an outlier key in the electronic document, wherein the one or more document features includes the one or more font properties; or
a proximity of the outlier key to the one or more keys in the electronic document; and
removing the one or more outlier keys from the one or more keys.

15. The system of claim 13, wherein associating one or more values to the one or more keys is based on one or more of:
a proximity of a value to a key in the electronic document; or
a content constraint on values associated with the key.

16. The system of claim 15, wherein associating one or more values to the one or more keys includes:
identifying a first candidate value for a key;
determining a first distance between the first candidate value and the key;
determining whether the first distance is within a threshold distance from the key; and
associating the first candidate value to the key based on determining that the first distance is within the threshold distance, wherein the key remains unassociated with a value when the first distance is greater than the threshold distance.

17. The system of claim 16, wherein associating one or more values to the one or more keys further includes:
identifying a plurality of candidate values for the key, wherein the plurality of candidate values includes the first candidate value; and
determining a distance between each of the plurality of candidate values and the key, wherein the first distance is the smallest distance from the determined distances.

18. The system of claim 15, wherein execution of the instructions causes the system to perform operations further comprising generating a plurality of values including the one or more values associated to the one or more keys, wherein generating the plurality of values includes one or more of:
generating a multi-tuple included in the one or more values, including:
dividing the text not included in the one or more keys in the electronic document into a plurality of 1-tuples; and
combining a portion of the plurality of 1-tuples into the multi-tuple based on one or more domain specific rules for the electronic document, wherein the multi-tuple is included in the plurality of values; or
segmenting values associated with an address key based on one or more address format rules.

19. The system of claim 12, wherein obtaining the text and one or more document features includes:
obtaining the electronic document; and
extracting the text and the one or more document features from the electronic document.

20. The system of claim 12, wherein execution of the instructions causes the system to perform operations further comprising filtering the text included in the one or more groups before identifying the one or more text strings.
